(19) United States
(12) Patent Application Publication
(10) Pub. No.: US 2024/0408707 A1
(43) Pub. Date: Dec. 12, 2024

(54) TIGHTENING DEVICE AND CONTROL METHOD

(71) Applicants: KABUSHIKI KAISHA TOSHIBA, Tokyo (JP); TOSHIBA ENERGY SYSTEMS & SOLUTIONS CORPORATION, Kawasaki-shi (JP)

(72) Inventors: Hideki OGAWA, Shinagawa (JP); Yoshiyuki ISHIHARA, Kawasaki (JP); Junichiro OOGA, Kawasaki (JP); Junji OAKI, Kawasaki (JP); Haifeng HAN, Yokohama (JP)

(73) Assignees: KABUSHIKI KAISHA TOSHIBA, Tokyo (JP); TOSHIBA ENERGY SYSTEMS & SOLUTIONS CORPORATION, Kawasaki-shi (JP)

(21) Appl. No.: 18/739,602

(22) Filed: Jun. 11, 2024

(30) Foreign Application Priority Data
Jun. 12, 2023 (JP) 2023-096157

(51) Int. Cl. B23P 19/06

(52) U.S. Cl. CPC B23P 19/067

(57) ABSTRACT

A tightening device includes a mobile part, a bolt tensioner, a bolt tensioner operation part, a positioning part, and a controller. The mobile part can be moved by driving control. The bolt tensioner performs a tightening operation for a bolt by operation of the operation part. The positioning part is mounted on the mobile part and is mounted with the bolt tensioner and the operation part, and positions a three-dimensional position of the bolt tensioner. The controller causes the mobile part to move so that a distance to the bolt falls within a certain value, causes the positioning part to operate so that the three-dimensional position becomes a position where the bolt is tightened after the mobile part is moved, and drives the operation part so that the bolt tensioner performs the tightening operation after the three-dimensional position is determined to be the position where the bolt is tightened.

### CROSS-REFERENCE TO RELATED APPLICATIONS

This application is based upon and claims the benefit of priority from Japanese Patent Application No. 2023-096157, filed on Jun. 12, 2023; the entire contents of which are incorporated herein by reference.

### FIELD

Embodiments described herein relate generally to a tightening device and a control method.

### BACKGROUND

A bolt (tightening bolt) for tightening a flange part of a windmill tower, which is a structure of a wind power generation facility, needs to be checked for looseness, and inspected for additional tightening to ensure that axial force or tightening torque is appropriate on a cycle (for example, one year) determined in a regular inspection guideline (for example, JEAG5005). Currently, inspection work is mainly performed manually, but the bolt inspection work (bolt tightening operation) is desired to be automated because the inspection work is heavy labor work involving danger at high places, working cost is high, and future labor shortages are concerned.

### BRIEF DESCRIPTION OF THE DRAWINGS

FIG. 1 is a side view of a tightening device according to an embodiment;

FIG. 2 is a top view of the tightening device according to the embodiment;

FIG. 3 is a diagram illustrating a configuration example of a hydraulic pressure supply part;

FIG. 4 is a diagram illustrating a configuration example of a mobile part;

FIG. 5 is a side view of a handling part;

FIG. 6 is a top view of the handling part;

FIG. 7 is a top view of the hydraulic pressure supply part;

FIG. 8 is a side view of the hydraulic pressure supply part;

FIG. 9 is a top view of the hydraulic pressure supply part;

FIG. 10 is a side view of the hydraulic pressure supply part;

FIG. 11 is a diagram illustrating an example of the hydraulic pressure supply part;

FIG. 12 is a flowchart of access processing according to the embodiment;

FIG. 13 is a diagram for explaining a specific example of the access processing;

FIG. 14 is a diagram illustrating an installation example of a marker;

FIG. 15 is a diagram for explaining an example of processing of moving a bolt tensioner;

FIG. 16 is a diagram for explaining an example of processing of positioning the bolt tensioner;

FIG. 17 is a diagram for explaining an example of processing of positioning the bolt tensioner;

FIG. 18 is a diagram for explaining an example of processing of positioning the bolt tensioner;

FIG. 19 is a diagram for explaining an example of processing of positioning the bolt tensioner; and

FIG. 20 is a flowchart of inspection processing according to the embodiment.

### DETAILED DESCRIPTION

In general, according to one embodiment, a tightening device includes: a mobile part configured to be able to move by driving control; a bolt tensioner configured to perform a tightening operation for a bolt; an operation part configured to operate the bolt tensioner by driving control; a positioning part that is mounted on the mobile part and is mounted with the bolt tensioner and the operation part, the positioning part being configured to position a three-dimensional position of the bolt tensioner; and a controller configured to: cause the mobile part to move so that a distance to the bolt falls within a certain value; cause the positioning part to operate so that the three-dimensional position becomes a position where the bolt is tightened after the mobile part is moved; and drive the operation part so that the bolt tensioner performs the tightening operation after the three-dimensional position is determined to be the position where the bolt is tightened.

Exemplary embodiments of a tightening device and a control method will be explained below in detail with reference to the accompanying drawings. The present invention is not limited to the following embodiments. The following describes tightening operation for a bolt used for tightening a flange part of a windmill tower as an example. However, an applicable facility is not limited to the windmill tower, but may be any other facility.

For example, the windmill tower has a structure in which flange parts disposed on a plurality of cylindrical structures are tightened by bolts. A plurality of floors corresponding to the flange parts are disposed for the tightening operation for the bolts, and an elevator is installed as moving means between the floors.

Automation of the tightening operation for the bolts has technical problems as described in (P1) to (P4) described below, for example.
(P1) Constraints on size and weight: The tightening device used for the tightening operation for the bolts is required to have a size (a width, a height, and a depth) and weight capable of being loaded on the elevator for moving between the floors. For example, assuming that inspection work is performed by a person (hereinafter, referred to as an inspector), an elevator with a maximum capacity of two adults is used. In a case of using such an elevator, the tightening device is required to be within a size and weight range of two adults.
(P2) Movement on floor: After the inspector has performed simple initial setting, the tightening device is required to be able to successively move to one or more bolts (hereinafter, referred to as target bolts) as inspection targets without any work performed by the inspector. At the time of movement, the tightening device is required to move to a position where it can access the target bolt while avoiding an obstacle and the like on the floor.
(P3) Positioning of bolt tensioner: A bolt tensioner is a tool used for additional tightening inspection for the target bolt, and is a heavy object that is 10 kg or more, for example. The bolt tensioner requires supply of high hydraulic pressure to apply required axial force to the target bolt at the time of inspection. After moving to the vicinity of the target bolt, the tightening device is required to accurately position the bolt tensioner, which is a heavy tool, to a position where the target bolt can be additionally tightened.
(P4) Operation of bolt tensioner: The bolt tensioner, which is assumed to be operated by the inspector, is required to be handled (operated) by the tightening device. For example, the tightening device is required to perform an operation of attaching the bolt tensioner, which is positioned with respect to the target bolt, to the target bolt, and tighten the target bolt with the attached bolt tensioner. The tightening device is also required to operate a hydraulic pump used for supplying hydraulic pressure.

As a bolt tensioner for tightening a bolt of an upper lid of a pressure vessel such as a heat exchanger, developed is a technique related to a bolt tensioner that runs along a rail as a guide and tightens a plurality of bolts. As a bolt tensioner for performing tightening operation and the like for a bolt of a flange part of a windmill tower, developed is a technique related to a bolt tensioner that runs on a flange surface and tightens a plurality of bolts. However, these techniques require work of installing the rail in advance, work of installing the bolt tensioner on the rail or on the flange surface, and the like, so that a load of the tightening operation for the bolt cannot be efficiently reduced.

The tightening device according to the present embodiment is configured to solve at least part of the technical problems as described above. For example, the tightening device can be caused to have a size and weight that can be loaded on the elevator installed as moving means between the floors. On the floor, the tightening device is not required to be operated by the inspector after simple initial setting is performed, and can successively move to the target bolt while avoiding an obstacle and the like on the floor. The tightening device positions, to the target bolt, the bolt tensioner equipped with a device (handling part) for handling the bolt tensioner. The tightening device operates the positioned bolt tensioner using the handling part. The tightening device can store, as information indicating a result of the inspection work, detection information obtained at the time of operation by the handling part.

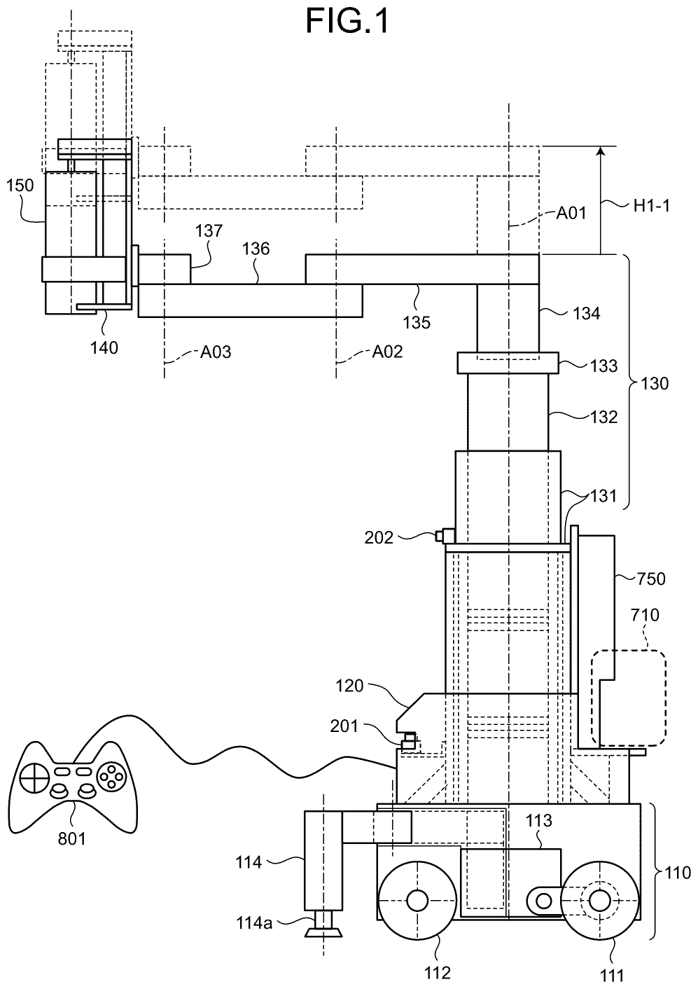

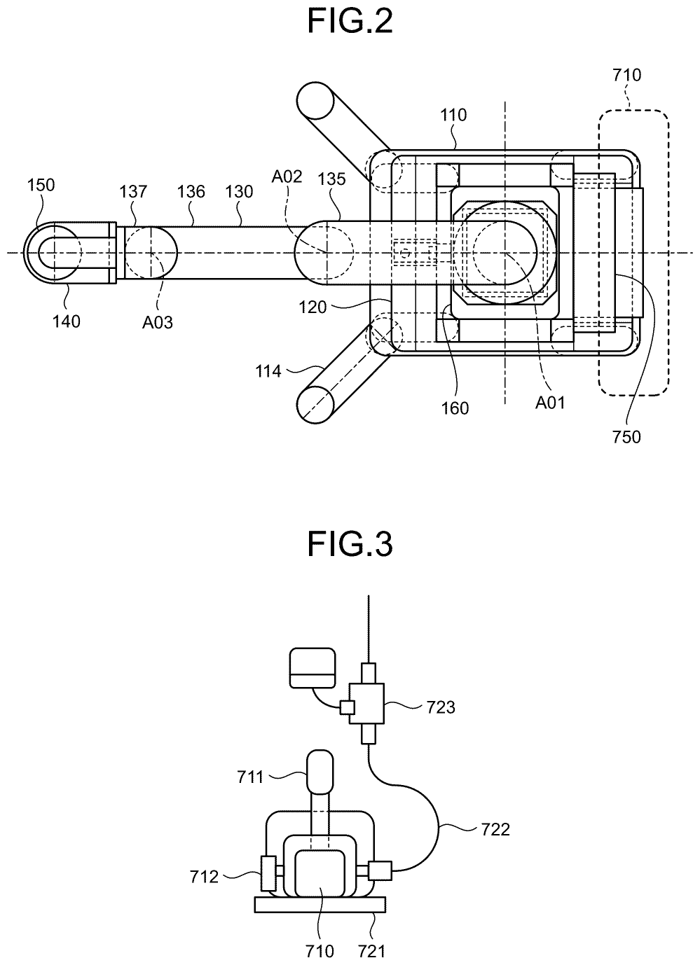

FIG. 1 and FIG. 2 are diagrams illustrating a configuration example of a tightening device 100 according to the embodiment. FIG. 1 is an example of a side view of the tightening device 100. FIG. 2 is an example of a top view of the tightening device 100.

The tightening device 100 includes, as main components, a mobile part 110, a controller 120, a positioning part 130, a handling part 140, a bolt tensioner 150, and a hydraulic pressure supply part 710. The tightening device 100 also includes a swing driving mechanism (swing driving part) 750, a laser range sensor 201, and a camera 202. Additionally, the tightening device 100 may be connected to an operating device 801.

The mobile part 110 can be moved by driving control by the controller 120, and causes the tightening device 100 to move toward the target bolt. The mobile part 110 includes, for example, driving wheels 111, auxiliary wheels 112, a battery 113, and outriggers 114. The outriggers 114 includes leg parts 114a.

The controller 120 functions as a control unit that controls operations of respective parts of the tightening device 100. For example, the controller 120 causes the mobile part 110 to move so that a distance to the target bolt falls within a certain value. The controller 120 also causes the positioning part 130 to operate so that a three-dimensional position of the bolt tensioner 150 becomes a position for tightening the target bolt after the mobile part 110 is moved. Furthermore, the controller 120 drives the handling part 140 so that the bolt tensioner 150 performs tightening operation after the three-dimensional position is determined to be the position for tightening the target bolt.

The controller 120 is, for example, implemented by one or a plurality of processors. For example, a function of the controller 120 may be implemented by causing a processor such as a central processing unit (CPU) and a graphics processing unit (GPU) to execute a computer program, that is, by software. The function of the controller 120 may also be implemented by a processor such as a dedicated integrated circuit (IC), that is, by hardware. The function of the controller 120 may be implemented by using both of software and hardware. In a case of using a plurality of processors, each of the processors may implement one of functions of the controller 120, or implement two or more of the functions of the controller 120.

The positioning part 130 is mounted with the bolt tensioner 150 that is grasped by the handling part 140, and positions the three-dimensional position of the bolt tensioner 150. The positioning part 130 is mounted on the mobile part 110.

The positioning part 130 includes a supporting part 131, a vertical driving part 132, an arm attaching/detaching part 133, an arm supporting part 134, and arms 135 to 137.

The supporting part 131 is mounted on the mobile part 110, and supports the vertical driving part 132. The vertical driving part 132 can be driven in an upper and lower direction with respect to the supporting part 131. As represented by a dashed line in FIG. 1, the vertical driving part 132 can drive the positioning part 130 in the upper and lower direction by a length H1-1.

The arm attaching/detaching part 133 is disposed on the vertical driving part 132, and configured to enable the arm supporting part 134 to be attached/detached. The arm supporting part 134 is a member that supports the arms 135 to 137. The arms 135, 136, and 137 can rotate about axes A01, A02, and A03, respectively, in accordance with rotation of motors (not illustrated) that are disposed corresponding to the respective arms.

The handling part 140 corresponds to an operation part that grasps the bolt tensioner 150 and operates the grasped bolt tensioner 150.

The bolt tensioner 150 performs a tightening operation of tightening the target bolt, and a loosening operation of loosening the target bolt. In the present embodiment, the bolt tensioner 150 is configured to be able to apply, to the target bolt, axial force corresponding to hydraulic pressure supplied from the hydraulic pressure supply part 710.

The hydraulic pressure supply part 710 supplies hydraulic pressure to the bolt tensioner 150. FIG. 3 is a diagram illustrating a configuration example of the hydraulic pressure supply part 710. FIG. 3 corresponds to a diagram in a case of observing the hydraulic pressure supply part 710 in a state of being mounted on the tightening device 100 from a side surface of the tightening device 100 similarly to the side view of FIG. 1. As illustrated in FIG. 3, the hydraulic pressure supply part 710 is installed on an attachment base plate 721 (attachment part), and includes a pressurizing bar 711 and an opening/closing valve lever 712 (switching part). The hydraulic pressure supply part 710 is connected to a pressure gauge 723 via a hydraulic hose 722.

The pressurizing bar 711 is a member for increasing hydraulic pressure by swing operation. The opening/closing valve lever 712 is a member for switching whether to apply hydraulic pressure. For example, the opening/closing valve lever 712 switches whether to open or close the opening/closing valve. The opening valve is caused to be in a closed state (ON) at the time of increasing (applying) hydraulic pressure, and is caused to be in an opened state (OFF) at the time of not applying hydraulic pressure. The pressure gauge 723 is a measuring instrument for detecting the hydraulic pressure applied by the hydraulic pressure supply part 710.

The swing driving mechanism 750 in FIG. 1 (FIG. 2) functions as a swing driving part that performs the swing operation of the pressurizing bar 711.

The controller 120 controls the swing driving mechanism 750 based on a value of the hydraulic pressure detected by the pressure gauge 723. For example, the controller 120 controls the swing operation of the pressurizing bar 711 by the swing driving mechanism 750 so that the detected hydraulic pressure reaches a target value corresponding to the axial force applied to the target bolt.

The laser range sensor 201 is an example of a detection part (first detection part) that detects detection information (first detection information) indicating at least one of a self-position of the tightening device 100 and an obstacle on the floor. For example, the laser range sensor 201 is an optical distance sensor of two-dimensional scanning type that measures a distance to an object while performing scanning with light. The laser range sensor 201 may be called Laser Rangefinder (LRF), Light Detection and Ranging (LIDAR), or the like in some cases. LIDAR of three-dimensional operation type may be used.

The camera 202 is an imaging device that takes an image of a front side of the tightening device 100. The controller 120 can detect, for example, the position of the target bolt by analyzing an image taken by the camera 202. The camera 202 is an example of a detection part (second detection part) for detecting the position of the target bolt. The position of the target bolt may be detected by using a marker indicating the position of the target bolt.

The following describes details about the respective parts illustrated in FIG. 1 and FIG. 2.

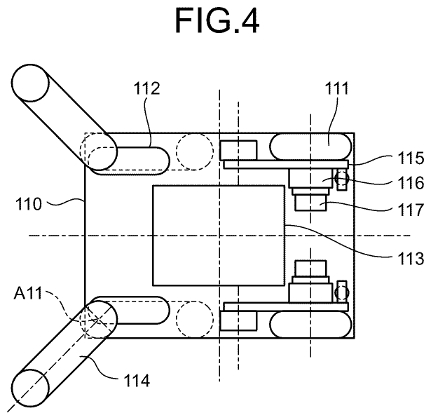

FIG. 4 is a diagram illustrating a configuration example of the mobile part 110. FIG. 4 is a top view of the mobile part 110. The mobile part 110 is controlled to autonomously move on the floor at the time of inspection work, and accesses the target bolt. For example, the mobile part 110 is configured to have a size (a width and a depth) capable of being loaded in the elevator for moving between the floors. For example, the mobile part 110 is configured to have a width of about 40 cm and a depth of about 50 cm.

As illustrated in FIG. 4, the mobile part 110 includes the driving wheels 111, the auxiliary wheels 112, the battery 113, the outriggers 114, a suspension 115, a decelerator 116, and a motor 117.

The driving wheels 111 correspond to a mobile-part driving part that enables forward movement, backward movement, turning, and movement along a circular arc track of the mobile part 110 as a traveling operation required for movement on the floor. For example, the driving wheels 111 are a two-wheel driving mechanism disposed on the left and the right of a rear part of the mobile part 110, which can be independently driven.

For example, the controller 120 causes the mobile part 110 to move so that a distance from the target bolt falls within a certain value by controlling the driving wheels 111 (motor 117) using the detection information detected by the laser range sensor 201 and the position of the target bolt detected by the camera 202. The controller 120 may further control movement of the mobile part 110 using map information. The map information is information indicating a position of a flange part of each floor, a position of an obstacle, and the like. The map information may be updated when a new obstacle is detected, for example.

The auxiliary wheels 112 are disposed on the left and the right of a front part of the mobile part 110. As the auxiliary wheel 112, for example, an omni wheel that does not horizontally rotate can be used.

As described above, the mobile part 110 is a wheel-driven mobile part, but may be driven by a driving mechanism other than the wheel.

The battery 113 is a power supply device that is disposed at the center on a bottom surface side of the mobile part 110 to supply power to the entire tightening device 100. The battery 113 may be a battery of any type, for example, a lithium ion battery.

The outriggers 114 are used for stabilizing balance of the center of gravity of the entire tightening device 100 at the time of inspection work. For example, the outriggers 114 are disposed on the left and the right of the front part of the mobile part 110. As represented by a dashed line in FIG. 4, the outriggers 114 can be stored in the mobile part 110, and can extend toward a front side of the mobile part 110 by rotating about an axis All as a center axis. That is, the outrigger 114 is configured to be able to extend toward a moving direction of the center of gravity corresponding to positioning of the bolt tensioner 150.

At the time of inspection work, the arms (arms 135 to 137) of the positioning part 130 may be caused to be in an extended state (posture) so that the bolt tensioner 150 moves to the vicinity of the target bolt. In such a case, the center of gravity of the entire tightening device 100 is positioned on the front side of the mobile part 110.

For example, the controller 120 causes the outriggers 114 stored in the mobile part 110 to rotate (spread) toward the front side of the mobile part 110, and causes the leg parts 114a to extend to a floor surface. Due to this, balance of the center of gravity of the entire tightening device 100 can be stabilized.

The suspension 115 is a buffer device for stabilizing movement of the mobile part 110. The decelerator 116 decelerates the driving wheels 111. The motor 117 corresponds to a driving part that causes the driving wheels 111 to rotate.

Next, the following describes control of the positioning part 130 mainly with reference to FIG. 2. After causing the mobile part 110 to move so that the distance to the target bolt falls within a certain value, the controller 120 causes the positioning part 130 mounted on the mobile part 110 to operate. That is, the controller 120 positions the bolt tensioner 150 (the handling part 140 that grasps the bolt tensioner 150) at a position where the bolt tensioner 150 can be attached to the target bolt.

For example, the positioning part 130 includes a driving mechanism having four or more degrees of freedom to position the bolt tensioner 150 and the posture thereof with respect to the target bolt in a three-dimensional space. In the present embodiment, the positioning part 130 includes a driving part having three or more degrees of freedom to move the bolt tensioner 150 in a specific direction DA (first direction). The direction DA is, for example, a horizontal direction. The direction DA can be interpreted as a direction parallel with the floor surface. Hereinafter, this driving part is referred to as a horizontal driving part (first driving part). For example, the arms 135 to 137 and the motors that rotate the respective arms 135 to 137 correspond to the horizontal driving part. In this case, the horizontal driving part performs driving at three degrees of freedom. By further adding an arm and a motor that rotates the arm, a horizontal driving part having a four or more degrees of freedom may be provided.

The positioning part 130 further includes a driving part that causes the bolt tensioner 150 to move in a direction DB (second direction) orthogonal to the direction DA. The direction DB is, for example, an upper and lower direction (vertical direction). The vertical driving part 132 corresponds to this driving part (second driving part).

In the present embodiment, a bottom surface of the bolt tensioner 150 is caused to access an upper part (head part) of the target bolt from an upper side. Due to this, the vertical driving part 132 is configured to have a length (stroke) for vertical driving required for attaching or detaching the bolt tensioner 150 to/from the target bolt. The length H1-1 illustrated in FIG. 1 corresponds to this length for vertical driving. The length H1-1 may be determined corresponding to a size of the target bolt or a height from the flange surface.

From a viewpoint of reducing a hand load, the vertical driving part 132 is disposed on the mobile part 110. A driving scheme for vertical driving may be any scheme. For example, a driving scheme by motor control using a ball screw may be applied, for example. For example, the ball screw is installed so that an axial direction of the screw agrees with the direction DB, and configured so that the vertical driving part 132 moves in the direction DB in accordance with rotation of the motor (for example, a motor with a decelerator).

Guide rails for guiding movement by the vertical driving part 132 are disposed at a plurality of points to be parallel with the ball screw on a side surface part of the supporting part 131, for example. Due to this, rigidity of hand load moment can be maintained.

The horizontal driving part (arms 135 to 137, and motors) is a driving part having three degrees of freedom that causes the bolt tensioner 150 to move in the horizontal direction to reduce influence of hand load gravity. Motor capacity can be reduced, so that the weight of the arm can be reduced due to downsizing of the motor.

For example, rotation of the arm 135 about the axis A01 as a center axis and rotation of the arm 136 about the axis A02 as a center axis correspond to two degrees of freedom mainly for causing the bolt tensioner 150 to horizontally move to an upper side of the target bolt. Rotation of the arm 137 about the axis A03 as a center axis corresponds to one degree of freedom mainly for controlling the posture of the bolt tensioner 150 about the center axis of the target bolt.

The controller 120 controls the positioning part 130 as follows, for example. First, the controller 120 controls the positioning part 130 (vertical driving part 132) to position the bolt tensioner 150 to be higher than the target bolt. In this state, the controller 120 causes the mobile part 110 to move to a position where a distance from the target bolt falls within a certain value. The controller 120 drives the horizontal driving part so that the bolt tensioner 150 horizontally moves to an upper position of the target bolt. After the bolt tensioner 150 is located at the upper position of the target bolt, the controller 120 drives the vertical driving part 132 so that the bolt tensioner 150 moves until contacting with the target bolt.

FIG. 1 and FIG. 2 illustrate a state in which the arms are extended to maximize a movement amount of the bolt tensioner 150 toward a front side of the tightening device 100. For example, at the time of moving between the floors, the arms may be in a folded state to reduce the movement amount. The tightening device 100 may be transported in a state in which the arm supporting part 134 is detached from the arm attaching/detaching part 133.

For example, the arm attaching/detaching part 133 may have a structure in which the arm supporting part 134 can be easily attached/detached by using an attachment jig for a cooperative arm.

The positioning part 130 is not limited to the example described above, but can be configured by using an arm of vertical articulated type configured to have four or more degrees of freedom, for example.

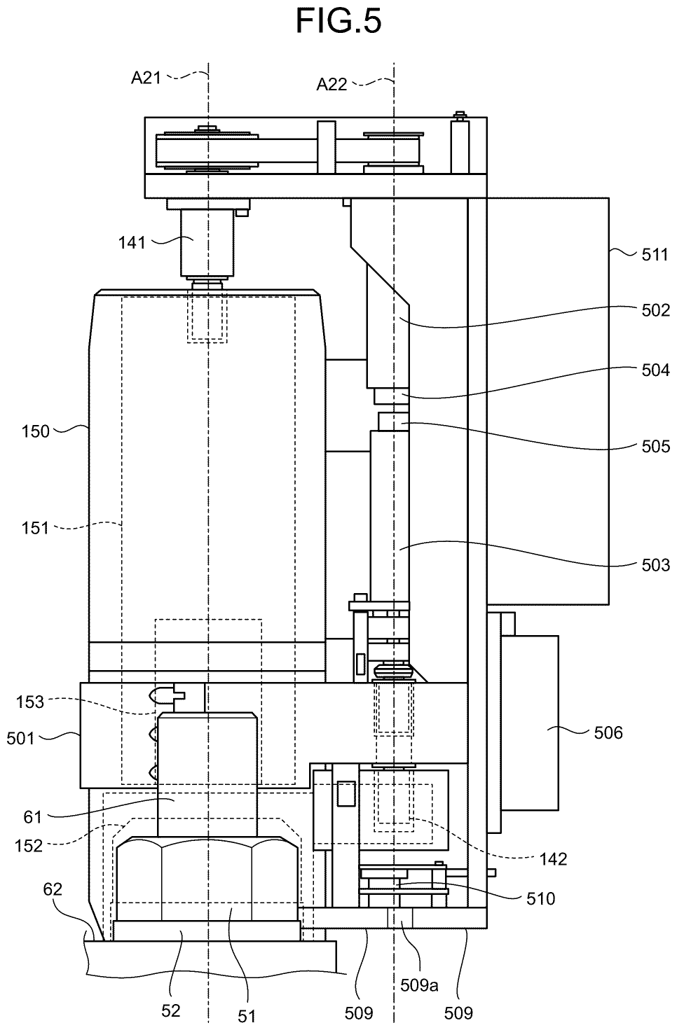

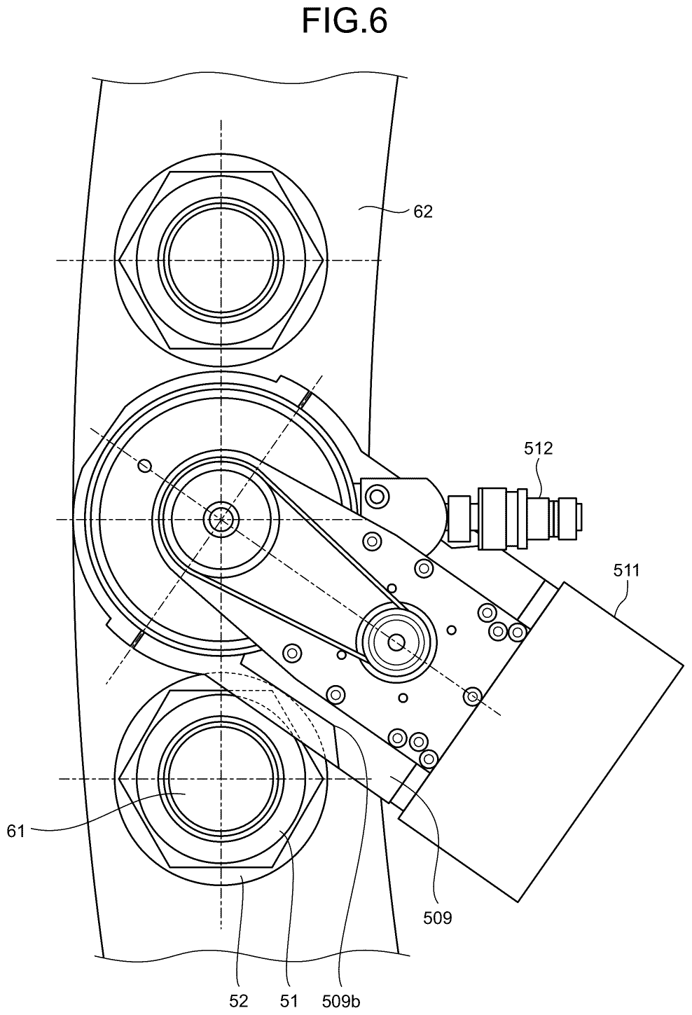

Next, the following describes a configuration example of the handling part 140 with reference to FIG. 5 and FIG. 6. FIG. 5 is an example of a side view of the handling part 140. FIG. 6 is an example of a top view of the handling part 140. FIG. 5 and FIG. 6 also illustrate the bolt tensioner 150 in a state of being grasped by the handling part 140, a target bolt 61, a nut 51 tightened to the target bolt 61, a washer 52, and a flange surface 62.

As illustrated in FIG. 5, the handling part 140 includes an upper wrench 141 and a lower wrench 142 for attaching the bolt tensioner 150 to the target bolt 61 to perform inspection work. The bolt tensioner 150 includes a female screw part 153, a female screw rotation part 151 that rotates the female screw part 153, and a nut rotation part 152 that rotates the nut 51.

The upper wrench 141 is a member for rotating the female screw part 153 inside the bolt tensioner 150 to be attached to an upper shaft of the target bolt 61. The upper wrench 141 is inserted into a wrench hole disposed on an upper surface of the bolt tensioner 150 to be rotated. Due to this, the female screw rotation part 151 is rotated, and the female screw part 153 is rotated in conjunction with the rotation of the female screw rotation part 151. The lower wrench 142 is a member for causing, after the female screw part 153 is attached to the target bolt 61, certain axial force to work in response to pressurization by the hydraulic pressure supply part 710, and rotating the nut 51 to be tightened in accordance with extension of the shaft of the bolt. The lower wrench 142 is inserted into a wrench hole disposed on a lower side surface part of the bolt tensioner 150 to be rotated. Due to this, the nut rotation part 152 is rotated, and the nut 51 is rotated in conjunction with the rotation of the nut rotation part 152. Axes A21 and A22 correspond to rotation axes of the upper wrench 141 and the lower wrench 142, respectively.

In a case of manual inspection work, the upper wrench 141 and the lower wrench 142 are inserted into respective wrench holes disposed on the bolt tensioner 150 to be operated by the inspector. In the present embodiment, the handling part 140 operates the upper wrench 141 and the lower wrench 142.

For such an operation, the handling part 140 includes a grasping part 501, motors 502 and 503, encoders 504 and 505, an arm connection part 506, a lower base plate 509, a bolt detection camera 510, and a controller 511.

The arm connection part 506 is a jig for connection with the arm 137 of the positioning part 130. The lower base plate 509 is a plate member corresponding to a bottom part of the handling part 140 to be pressed against a side surface on a lower side of the bolt tensioner 150.

The grasping part 501 grasps, from both sides, the side surface of the bolt tensioner 150 against which the lower base plate 509 is pressed. The bolt tensioner 150 may have a structure in which a portion (for example, an upper part) having a connection part 512 (refer to FIG. 6) to be connected with the hydraulic hose 722 can rotate. In such a case, the grasping part 501 is configured to grasp a portion (for example, a lower part) of the bolt tensioner 150 that does not rotate.

The bolt tensioner 150 is fixed to the handling part 140 by the grasping part 501 and the lower base plate 509, and can move together with the handling part 140.

The motor 502 is a driving part for rotating the upper wrench 141. In the example of FIG. 5, the motor 502 is configured to rotate about the axis A22 as the center, and transmit rotational power to the upper wrench 141 rotating about the axis A21 via a belt. The motor 503 is a driving part for rotating the lower wrench 142. The motor 502 corresponds to a female screw rotational driving part that rotates the upper wrench 141 to rotate the female screw part inside the bolt tensioner 150 into which the upper wrench 141 is inserted. The motor 503 corresponds to a nut rotational driving part that rotates the inserted lower wrench 142 to rotate the nut 51 to tighten the target bolt.

The encoders 504 and 505 correspond to detection parts (third detection parts) that detect rotation amounts of the motors 502 and 503, respectively. The rotation amount is an example of detection information (second detection information) obtained at the time of operation by the handling part 140. The controller 120 may store the detection information such as the detected rotation amount in a storage device provided inside the controller 120, for example. Due to this, processing of storing a result of inspection work can be automated, for example.

In the example of FIG. 5, the motors 502 and 503, and the encoders 504 and 505 are arranged on the rotation axis (axis A22) of the lower wrench 142. Due to this, the structure of the handling part 140 can be made more compact.

The bolt detection camera 510 is an imaging unit used for taking an image of the target bolt 61 and detecting the target bolt 61. For example, the controller 120 causes the positioning part 130 to move to a position where an image of the target bolt 61 is taken by the bolt detection camera 510. After the movement, the controller 120 causes the positioning part 130 to move by driving control using the image taken by the bolt detection camera 510 so that the bolt tensioner 150 is positioned to tighten the target bolt 61, that is, the bolt tensioner 150 is positioned on the center axis of the target bolt 61.

The controller 511 is a control unit (motor driver) that controls driving of the motors 502 and 503. The controller 511 drives the motors 502 and 503 in accordance with an instruction from the controller 120, for example.

A hole 509a (refer to FIG. 5) is disposed on the lower base plate 509 so that the bolt detection camera 510 can take an image of a lower side. The lower base plate 509 may have a depressed shape with a depression near the center. That is, a notch part 509b (refer to FIG. 6) may be disposed on the lower base plate 509. For example, the notch part 509b is disposed to avoid interference with the nut 51 and the washer 52 disposed on the left and the right at the time of attaching the bolt tensioner 150 to the target bolt 61. Due to this, it is possible to widen a range of rotation of the arm 137 about the axis A03 as a center axis, in other words, a range for controlling the posture of the bolt tensioner 150.

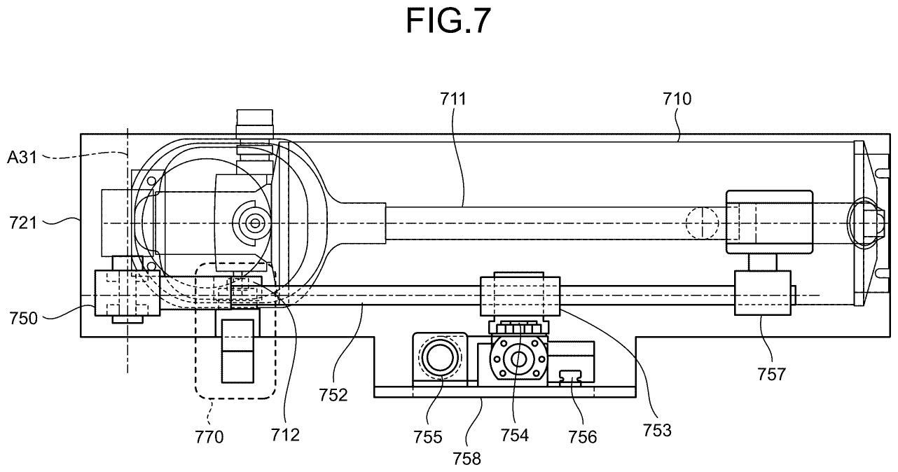

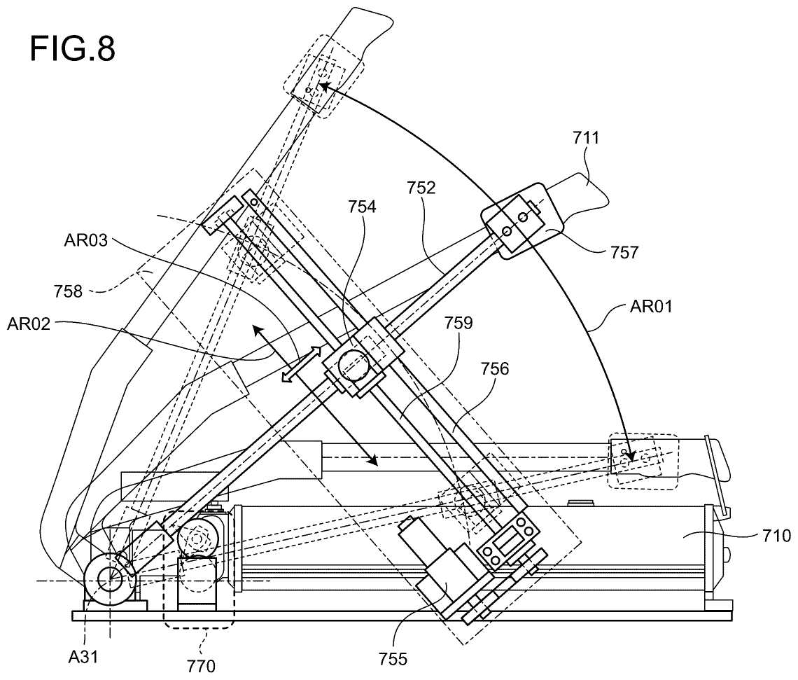

Next, the following describes a configuration example of the hydraulic pressure supply part 710 and the swing driving mechanism 750 with reference to FIG. 7 to FIG. 10. FIG. 7 is an example of a top view of the hydraulic pressure supply part 710 on which the swing driving mechanism 750 is mounted. FIG. 8 is an example of a side view of the hydraulic pressure supply part 710 on which the swing driving mechanism 750 is mounted.

The hydraulic pressure supply part 710 can supply hydraulic pressure (for example, 90 MPa) required for the bolt tensioner 150 to exert high axial force (for example, 600 kN), and can be configured by a hand-type hydraulic pump, for example. The hand-type hydraulic pump includes the pressurizing bar 711 that can be manually swung, and supplies hydraulic pressure pressurized in accordance with swing of the pressurizing bar 711.

The hydraulic pressure supply part 710 is not limited to the hand-type hydraulic pump, but may be an air-type hydraulic pump and an electric hydraulic pump, for example.

By using the hand-type hydraulic pump, the structure can be simplified, and the size can be made compact. Additionally, it is not necessary to prepare another device such as a compressor for supplying pressurized air to the hydraulic pump. Due to this, attachment to the tightening device 100 and detachment from the tightening device 100 can be facilitated. Furthermore, it becomes easy to move between the floors by the elevator in a state of being mounted on the tightening device 100.

As illustrated in FIG. 7, the hydraulic pressure supply part 710 is installed on the attachment base plate 721. In a case of using the hydraulic pressure supply part 710, first, the opening/closing valve lever 712 is rotated to cause the opening valve to be in the closed state (ON). Thereafter, the swing operation is performed on the pressurizing bar 711 multiple times to increase the hydraulic pressure.

A rotational driving part 770 corresponds to a driving part for rotating the opening/closing valve lever 712, that is, a driving part (switching driving part) for performing a switching operation of the opening/closing valve lever 712 (switching part). The rotational driving part 770 is, for example, implemented by a motor and the like that rotates in accordance with control by the controller 120. The rotational driving part 770 may be disposed on a rotation axis of the opening/closing valve lever 712, or may be disposed on an axis via a spur gear and the like.

The swing driving mechanism 750 includes a guide shaft 752, a linear ball bush 753, a coupling part 754, a motor 755, a linear guide 756, a grasping part 757, a base plate 758, and a ball screw 759.

The guide shaft 752 is a member for guiding the linear ball bush 753 that moves in accordance with the swing operation. The guide shaft 752 is configured to perform swing operation (swing and rotate) about an axis A31 as the center, which is the same center axis as that of the pressurizing bar 711. An arrow AR01 in FIG. 8 represents a direction of the swing operation.

The linear ball bush 753 is installed to linearly move along the guide shaft 752.

The coupling part 754 is a member for coupling the linear ball bush 753 (guide shaft 752) with a nut part of the ball screw 759.

The motor 755 is a driving part for rotating the ball screw 759. The motor 755 is configured by a motor with a decelerator, for example.

The linear guide 756 is a member for guiding the coupling part 754 to linearly move following rotation of the ball screw 759.

The grasping part 757 is disposed on an end part different from an end part corresponding to the axis A31 of both ends of the guide shaft 752, and grasps the pressurizing bar 711. Due to this, the pressurizing bar 711 can also perform swing operation following the swing operation of the guide shaft 752.

The base plate 758 is a member for installing the motor 755, the linear guide 756, and the ball screw 759.

The ball screw 759 is configured so that the coupling part 754 moves in an axial direction in accordance with the rotation of the motor 755. An arrow AR02 represents a direction in which the coupling part 754 moves. An arrow AR03 represents a direction in which the linear ball bush 753 moves in accordance with the movement of the coupling part 754.

For example, the controller 120 controls the motor 755 to rotate the ball screw 759 so that the coupling part 754 (linear ball bush 753) moves in a direction away from the motor 755. Due to this, the pressurizing bar 711 is swung to be lifted upward. The controller 120 decelerates the rotation of the motor 755 so that the movement of the pressurizing bar 711 is stopped before reaching an upper limit of a movable range (limit of upward movement) of the pressurizing bar 711. Next, the controller 120 controls the motor 755 to rotate the ball screw 759 so that the coupling part 754 (linear ball bush 753) moves in a direction approaching the motor 755. Due to this, the pressurizing bar 711 is swung to move downward. The controller 120 decelerates the rotation of the motor 755 so that the movement of the pressurizing bar 711 is stopped before reaching a lower limit of the movable range (limit of downward movement) of the pressurizing bar 711. By repeating such an operation, it is possible to cause the pressurizing bar 711 to perform swing operation, and increase the hydraulic pressure supplied from the hydraulic pressure supply part 710.

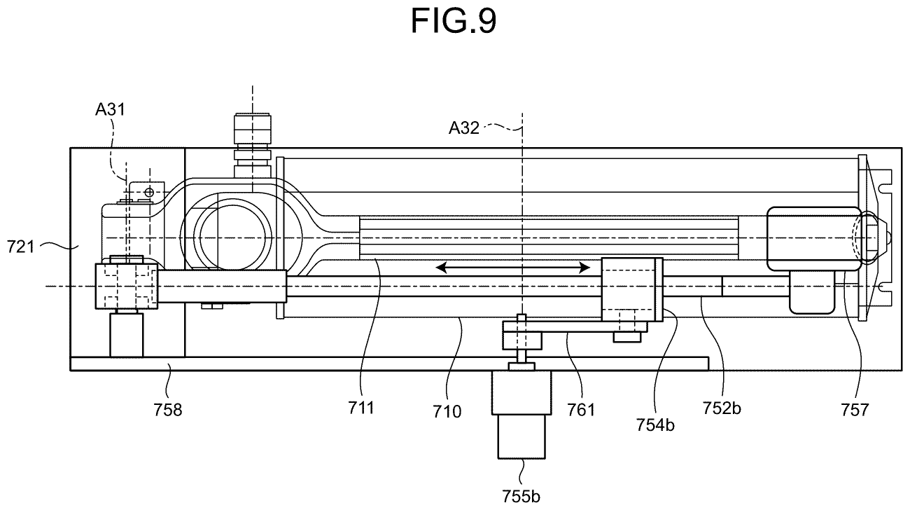

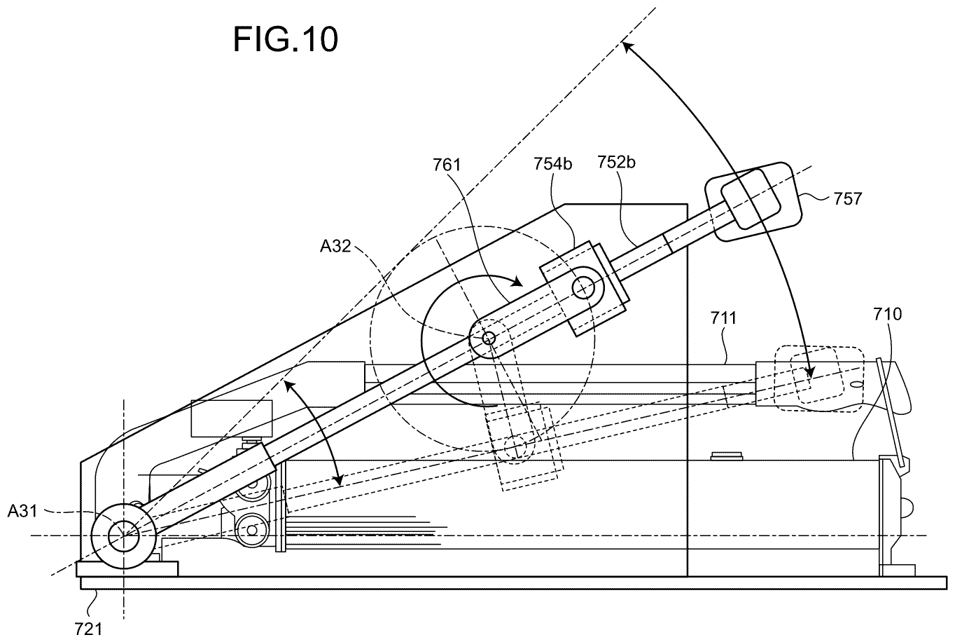

The configuration of the swing driving mechanism 750 is not limited to the configuration illustrated in FIG. 7 and FIG. 8, but may be any configuration that can cause the pressurizing bar 711 to perform the swing operation. FIG. 9 and FIG. 10 are diagrams illustrating another configuration example of the swing driving mechanism 750. FIG. 9 is an example of a top view of the hydraulic pressure supply part 710 on which the swing driving mechanism 750 is mounted. FIG. 10 is an example of a side view of the hydraulic pressure supply part 710 on which the swing driving mechanism 750 is mounted.

The swing driving mechanism 750 in FIG. 9 and FIG. 10 rotates a link 761 coupled to the guide shaft 752 in one direction to swing the pressurizing bar 711.

The swing driving mechanism 750 in FIG. 9 and FIG. 10 includes a guide shaft 752b, a coupling part 754b, a motor 755b, the grasping part 757, the base plate 758, and the link 761. The same configuration as that in FIG. 7 and FIG. 8 is denoted by the same reference numeral, and redundant description will not be repeated.

The guide shaft 752b is a member for guiding the coupling part 754b that moves in accordance with the swing operation. The coupling part 754b is a member for coupling the guide shaft 752b with the link 761. The motor 755b is a driving part for rotating the link 761.

The link 761 rotates in accordance with rotation of the motor 755b. An axis A32 corresponds to a center axis of rotation of the link 761. The link 761 is rotated in one direction as indicated by a clockwise arrow in FIG. 10. In accordance with this rotation, the guide shaft 752b is swung, and the pressurizing bar 711 is also swung.

The hydraulic pressure supply part 710 is required to be used in a horizontal state in some cases. If the hydraulic pressure supply part 710 is attached to the tightening device 100 in the horizontal state, there may be a situation in which it cannot be loaded on the elevator used for movement between the floors, for example. In such a case, for example, the hydraulic pressure supply part 710 may be transported in a state of being detached from the tightening device 100 at the time of movement between the floors, and attached to the tightening device 100 in the horizontal state before inspection work.

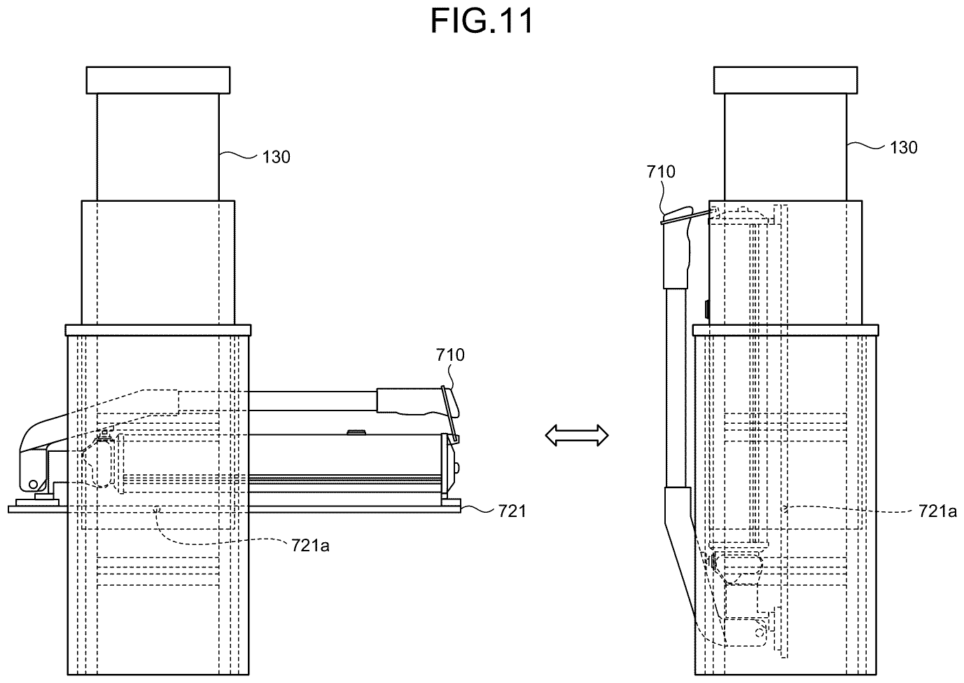

The hydraulic pressure supply part 710 may be configured to be able to change the orientation thereof in a state of being attached to the tightening device 100. FIG. 11 is a diagram illustrating an example of the hydraulic pressure supply part 710 in a case of being configured in this way. FIG. 11 only illustrates the hydraulic pressure supply part 710 and the positioning part 130 as a member to which the hydraulic pressure supply part 710 is attached, and does not illustrate other constituent elements.

The attachment base plate 721 includes a rotation shaft 721a to change the orientation of the hydraulic pressure supply part 710. For example, the attachment base plate 721 is attached to the positioning part 130 to be able to rotate about the rotation shaft 721a as the center. A left part of FIG. 11 illustrates an example in which the orientation of the hydraulic pressure supply part 710 is in the horizontal state. A right part of FIG. 11 illustrates an example in which the orientation of the hydraulic pressure supply part 710 is rotated about the rotation shaft 721a as the center by 90 degrees to be in a vertical state.

Due to such a configuration, for example, the hydraulic pressure supply part 710 can be caused to be in the vertical state at the time of moving in a small space such as the inside of the elevator, and the hydraulic pressure supply part 710 can be caused to be in the horizontal state at the time of moving in a large space such as on the floor. That is, even in a state in which the hydraulic pressure supply part 710 is attached to the tightening device 100, it can be loaded on the elevator (can move between the floors).

Next, the following describes a procedure of operation control in the inspection work for the target bolt by the tightening device 100. First, the following describes processing of moving to the target bolt 61 on the floor, and causing the bolt tensioner 150 to move to an upper side of the target bolt 61 (hereinafter, referred to as access processing).

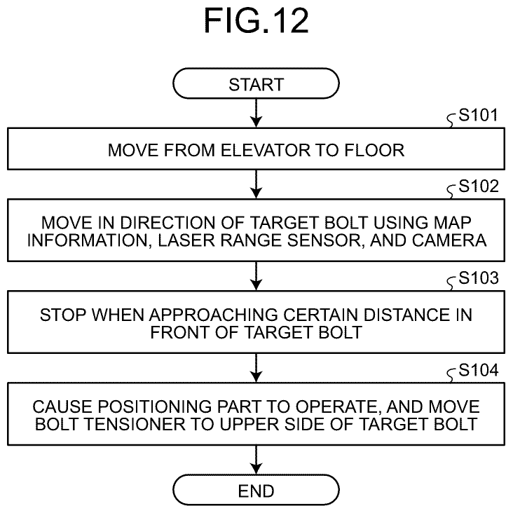

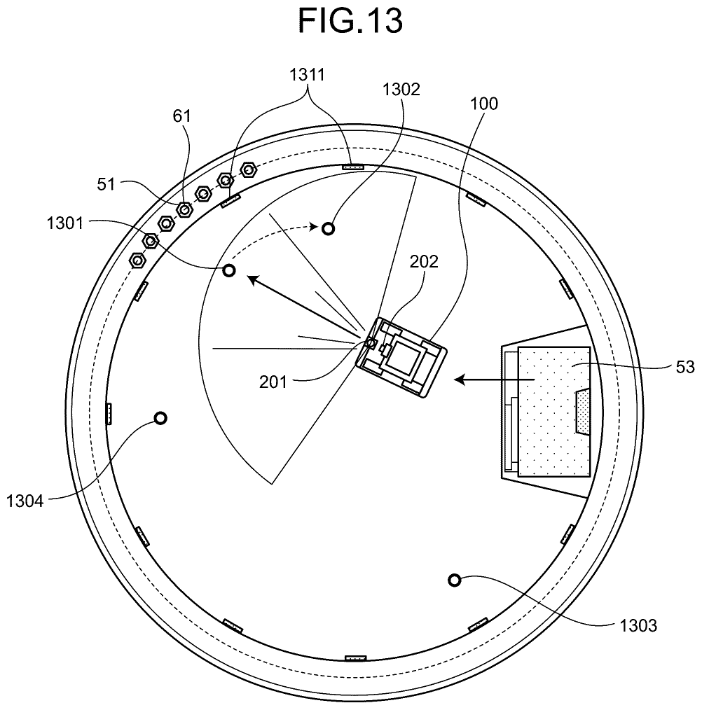

FIG. 12 is a flowchart illustrating an example of the access processing according to the embodiment. The following describes processing after a time point when the tightening device 100 is moved to the floor on which the target bolt 61 is disposed using the elevator. FIG. 13 is a diagram for explaining a specific example of the access processing. FIG. 13 is a diagram illustrating an example of observation from an upper side of the floor.

The tightening device 100 moves from an elevator 53 (refer to FIG. 13) to the floor (Step S101). For example, the tightening device 100 (controller 120) grasps a self-position based on the detection information from the laser range sensor 201, and moves to the floor. The movement to the floor may be performed by the inspector. The inspector may perform required settings such as mounting of the hydraulic pressure supply part 710, and connection between the hydraulic pressure supply part 710 and the pressure gauge 723 via the hydraulic hose 722.

The controller 120 controls movement by the mobile part 110 to move in the direction of the target bolt 61 while grasping the self-position of the tightening device 100 using the map information, the detection information from the laser range sensor 201, and the image taken by the camera 202 (Step S102).

In the example of FIG. 13, markers 1311 for detecting the position of the target bolt 61 are used. For example, the markers 1311 may be disposed corresponding to target bolts 61 as part (for example, 10 bolts determined from every 10 bolts) of a plurality of (for example, 100) bolts disposed on each floor, the part determined in advance as inspection targets.

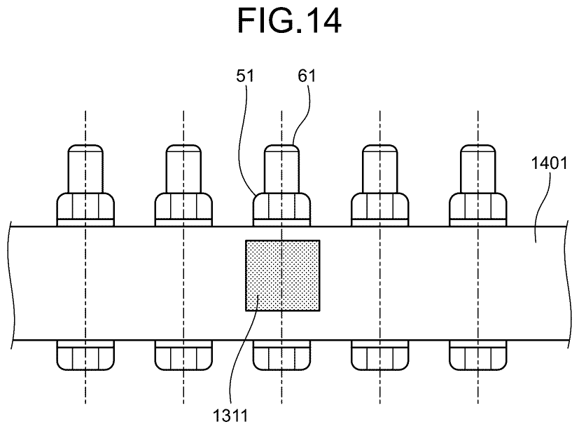

FIG. 14 is a diagram illustrating a disposition example of the marker 1311. As illustrated in FIG. 14, the marker 1311 is affixed to a position corresponding to the target bolt 61 on a front surface 1401 of the flange part, for example. In a case in which a plurality of the target bolts 61 are present, a plurality of the markers 1311 are affixed to the front surface 1401 at intervals of a certain number of bolts (for example, 10 bolts) so that the corresponding target bolts 61 can be identified.

The marker 1311 may be disposed for each of all the bolts disposed on the flange part. In this case, among all the bolts, a designated bolt or a randomly selected bolt may be caused to be a target of the inspection work as the target bolt 61.

The controller 120 can identify the marker 1311 through image processing on the image taken by the camera 202, for example. The marker 1311 is, for example, a QR code (registered trademark), an augmented reality (AR) marker, a bar code, or the like.

Returning to FIG. 12, the controller 120 controls the mobile part 110 to stop when approaching a certain distance substantially in front of the target bolt 61 (Step S103). In the example of FIG. 13, a stop position 1301 corresponds to a position where a distance from the front of the target bolt 61 falls within a certain value.

Stop positions 1302 to 1304 correspond to stop positions corresponding to the other target bolts. In a case in which a plurality of target bolts are present, which of the target bolts is approached and order of approaching the target bolt are determined based on a work instruction and the like instructed in advance, for example. For example, as indicated by an arrow of a dashed line, a pattern of successively moving to an adjacent target bolt along the flange part may be used. The pattern may be a pattern of successively inspecting a target bolt at a longer distance than the adjacent target bolt (for example, a star pattern).

The controller 120 starts operation of the positioning part 130, causes the bolt tensioner 150 to move to an upper side in the vicinity of the target bolt 61 (Step S104), and ends the access processing.

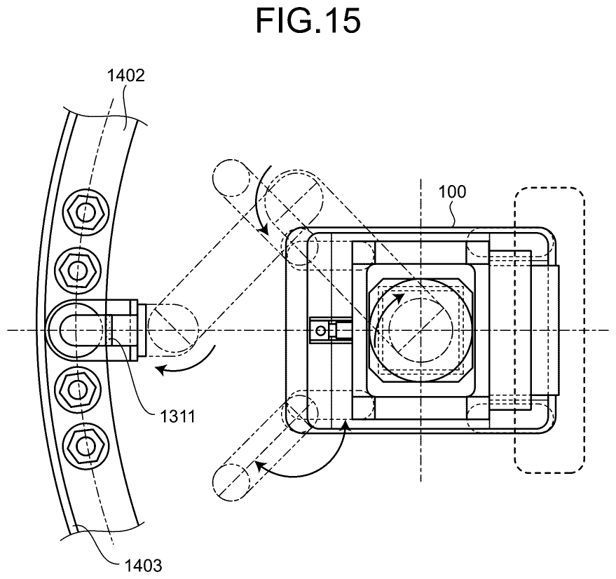

FIG. 15 is a diagram for explaining an example of the processing at Step S104.

After approaching the certain distance substantially in front of the target bolt 61, the controller 120 stops the mobile part 110, spreads the outrigger 114 as needed, and brings the leg part 114a into contact with the floor surface. The controller 120 also causes the positioning part 130 to operate from an initial posture state (home position) to a reference posture state.

The initial posture state is, for example, a state in which the arms are folded. The reference posture state is a state indicating posture as a reference at the time of starting the inspection work. FIG. 15 illustrates an example of the reference posture state. FIG. 15 illustrates an example of the reference posture state in which the axis A01 is rotated by 45 degrees, the axis A02 is rotated by 90 degrees, and the axis A03 is rotated by 45 degrees. The reference posture state is, for example, determined in advance as posture with which the bolt tensioner 150 can be moved to the upper side in the vicinity of the target bolt 61 when approaching the certain distance in front of the target bolt 61.

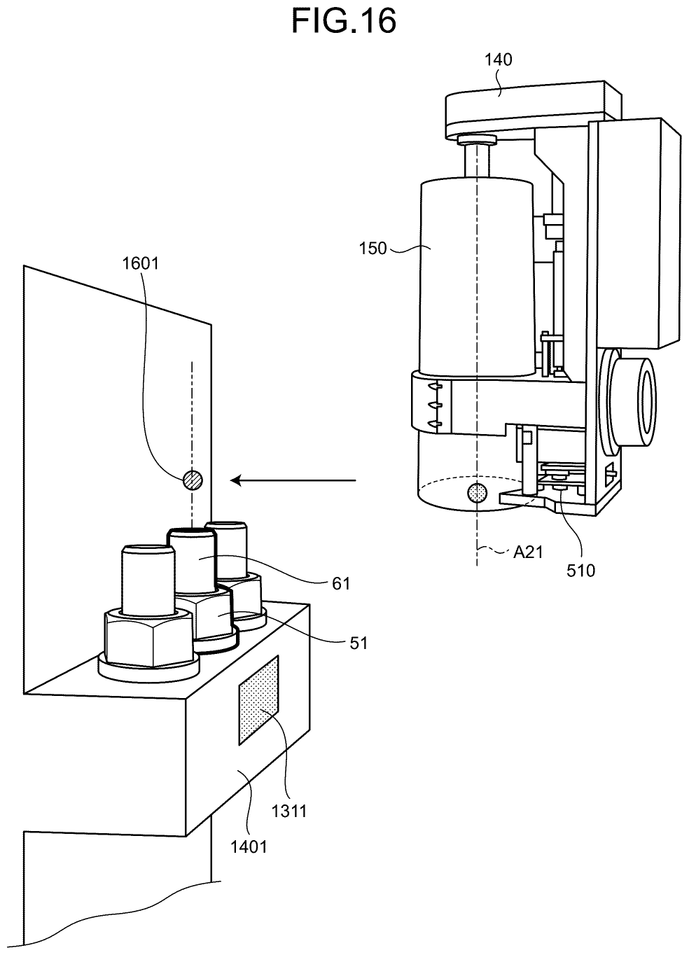

FIG. 16 to FIG. 19 are diagrams for explaining an example of the processing of positioning the bolt tensioner 150 with respect to the target bolt. FIG. 16 to FIG. 19 illustrate only the handling part 140 and the bolt tensioner 150 among the constituent elements of the tightening device 100, and do not illustrate the other constituent elements.

In FIG. 16, the controller 120 drives the horizontal driving part (the arms 135 to 137, the motor, and the like) and the vertical driving part 132 to move the bolt tensioner 150 to the upper side in the vicinity of the target bolt 61 so that an upper part of the target bolt 61 is included in an angle of view of the bolt detection camera 510. A positioning point 1601 corresponds to a point for positioning the center axis A21 of the bolt tensioner 150 on the center axis of the target bolt 61.

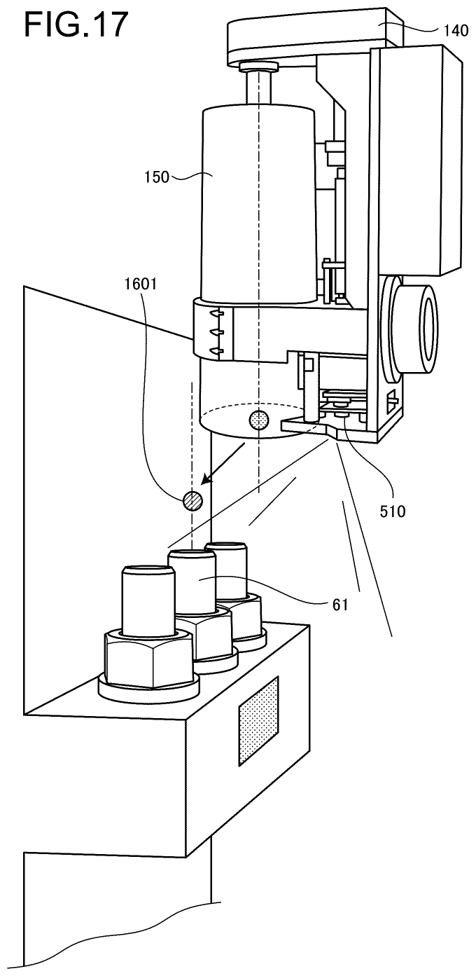

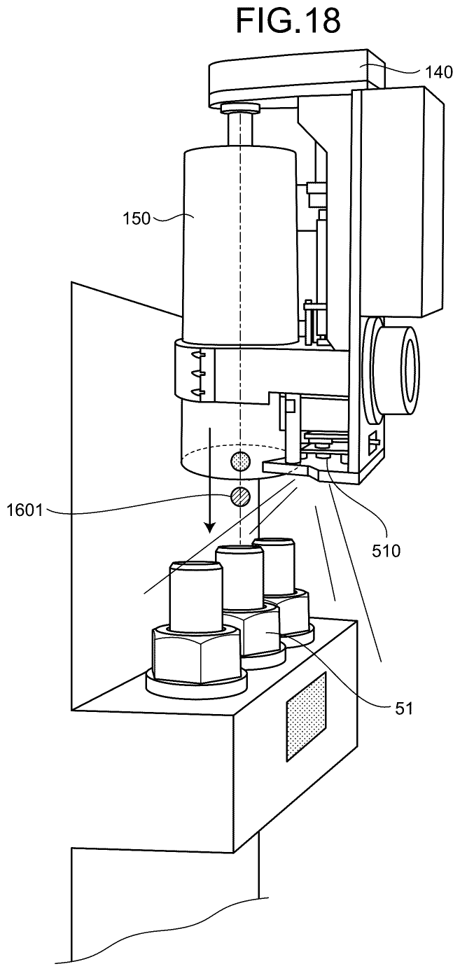

In FIG. 17, the controller 120 causes the bolt tensioner 150 to move so that the center axis A21 of the bolt tensioner 150 is positioned on the positioning point 1601 using image processing for bolt axis detection on the image taken by the bolt detection camera 510.

In FIG. 18, after the center axis of the target bolt 61 and the center axis A21 of the bolt tensioner 150 are aligned, the controller 120 causes the vertical driving part 132 to operate to go down until the upper part of the target bolt 61 is brought into contact with the female screw part inside the bolt tensioner 150.

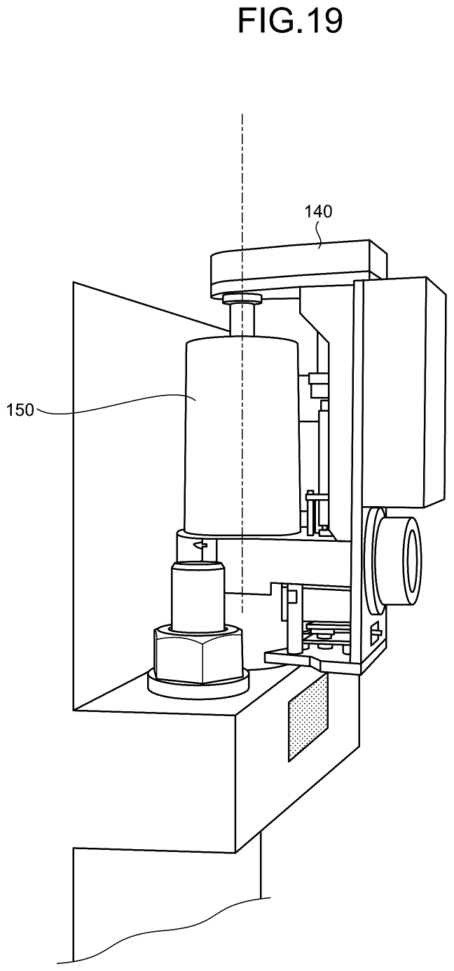

The controller 120 rotationally drives the motor 502 of the handling part 140 to attach the bolt tensioner 150 to the target bolt 61. FIG. 19 illustrates a state in which the bolt tensioner 150 is attached to the target bolt 61.

The controller 120 determines whether the upper surface of the flange part is in contact with the bottom surface of the bolt tensioner 150 by a method for comparison with a target value of force (torque) using force control by the motor 502, a method for detecting variation in a current value of the motor 502, and the like. The controller 120 also drives the vertical driving part 132 so that the bolt tensioner 150 is lowered by a movement amount corresponding to a screw pitch of the target bolt 61 in accordance with rotational driving (rotational speed) of the motor 502. Due to this, smooth work of attaching the bolt tensioner 150 can be implemented.

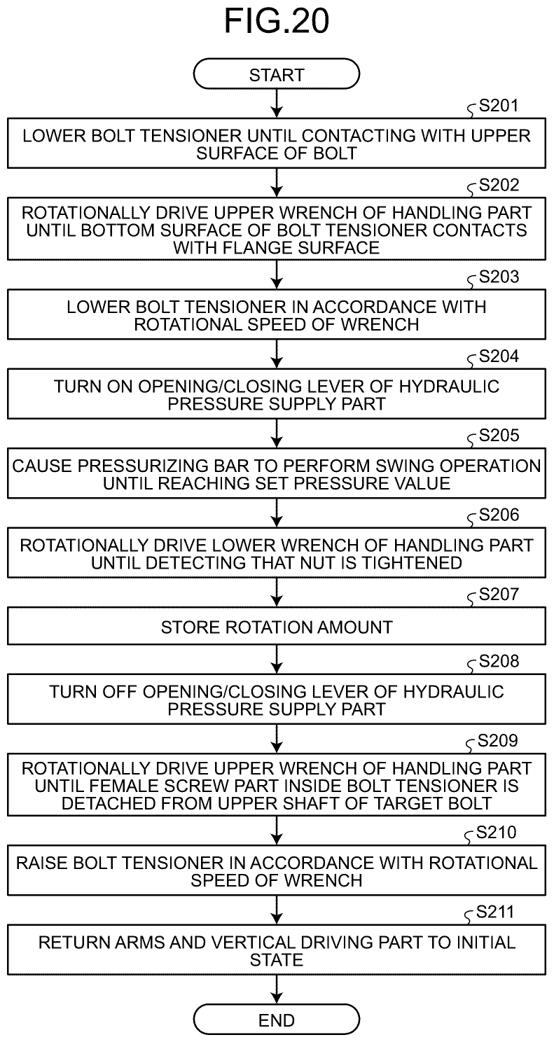

FIG. 20 is a flowchart illustrating an example of the inspection processing according to the embodiment. The inspection processing in FIG. 20 corresponds to processing after the center axis of the target bolt 61 and the center axis A21 of the bolt tensioner 150 are completely aligned as in FIG. 18, for example.

The inspection processing in FIG. 20 can be divided mainly into four functions as follows:
(F1) Attachment of the bolt tensioner 150 to the target bolt 61: Step S201 to Step S203;
(F2) Addition (pressurization) of axial force to the target bolt 61: Step S204 to Step S205;
(F3) Rotation of the nut 51 with respect to the target bolt 61 to which the axial force is applied: Step S206 to Step S207; and
(F4) Release of the axial force on the target bolt 61, and detachment of the bolt tensioner 150: Step S208 to Step S211.

The controller 120 drives the vertical driving part 132 to lower the bolt tensioner 150 until contacting with the upper surface of the target bolt 61 (Step S201). At this point, phase alignment for the nut 51 is not required. The controller 120 drives the motor 502 to rotate the upper wrench 141 of the handling part 140 until the bottom surface of the bolt tensioner 150 contacts with the upper surface of the flange part (Step S202). The controller 120 drives the vertical driving part 132 so that the bolt tensioner 150 is lowered by a movement amount corresponding to the screw pitch of the target bolt 61 in accordance with a rotational speed of the upper wrench 141 (Step S203).

The controller 120 drives the rotational driving part 770 to close (turning ON) the opening/closing valve lever 712 of the hydraulic pressure supply part 710 (Step S204). For example, the controller 120 causes the motor as the rotational driving part 770 to rotate clockwise. The controller 120 drives the swing driving mechanism 750 to cause the pressurizing bar 711 of the hydraulic pressure supply part 710 to perform swing operation until reaching a set pressure value (Step S205).

The controller 120 drives the motor 503 to rotate the lower wrench 142 of the handling part 140 until detecting that the nut 51 is tightened (Step S206). The controller 120 measures a rotation amount of the motor 503 at this point to be stored in a storage device and the like (Step S207). The stored information can be used for work such as checking and managing a loosening amount of the nut 51, for example.

The controller 120 drives the rotational driving part 770 to open (turning OFF) the opening/closing valve lever 712 of the hydraulic pressure supply part 710 (Step S208). For example, the controller 120 causes the motor as the rotational driving part 770 to rotate counterclockwise. The controller 120 drives the motor 502 to rotate the upper wrench 141 of the handling part 140 until the female screw part inside the bolt tensioner 150 is detached from the upper shaft of the target bolt 61 (Step S209). The controller 120 drives the vertical driving part 132 so that the bolt tensioner 150 is raised by a movement amount corresponding to the screw pitch of the target bolt 61 in accordance with the rotational speed of the upper wrench 141 (Step S210). The controller 120 returns the horizontal driving part (the arms 135 to 137, the motor, and the like) and the vertical driving part 132 to the initial posture state (Step S211), and ends the inspection processing.

In a case in which there is the target bolt 61 as the next inspection target, the controller 120 causes the tightening device 100 to move to the next target bolt 61, and further performs the inspection processing as described above. Due to this, the inspection work is performed for all of the target bolts 61 on the floor.

Each of the functions described above is required to determine (detect) the end of the operation. For example, at each step, it is necessary to detect events as follows.
Step S202: The bottom surface of the bolt tensioner 150 is brought into contact with the upper surface of the flange part
Step S204: The opening/closing valve lever 712 stops on an ON side
Step S205: A value measured by the pressure gauge 723 reaches the set pressure value
Step S206: The nut 51 is tightened to the target bolt 61 to which the axial force is applied

Step S205 can be implemented by comparing the measured value with the set pressure value. The other pieces of processing can be implemented by applying force control to the driving part (the motor and the like) to be used, for example. For example, the controller 120 detects the end of the operation depending on whether torque (force) generated by driving has reached a target value.

A method for detecting the end of the operation is not limited to the method using force control, but may be any other method. For example, the controller 120 may use a method for detecting the end of the operation based on variation of a current for driving the driving part. For example, the controller 120 can detect the end of the operation depending on whether a variation amount of the current for driving the driving part becomes equal to or larger than a target set value even in a case of performing position control for the driving part.

The processing of turning OFF the opening/closing valve lever 712 at Step S208 can be implemented by rotating the opening/closing valve lever 712 in a reverse direction by the same rotation amount as the rotation amount at the time when the opening/closing valve lever 712 is turned ON at Step S204. Similarly, the processing of rotating the upper wrench 141 until the female screw part inside the bolt tensioner 150 is detached from the shaft of the target bolt 61 at Step S209 can be implemented by rotating the upper wrench 141 in a reverse direction by the same rotation amount as the rotation amount of the upper wrench 141 at the time when the female screw part inside the bolt tensioner 150 is attached to the shaft of the target bolt 61 at Step S202.

Through the processing as described above, the tightening device 100 can perform a series of pieces of the inspection work for the bolts. The tightening device 100 may be configured to perform the inspection work in accordance with an instruction by the inspector as needed. The operating device 801 (refer to FIG. 1) is a device used by the inspector to input the instruction in such a case. The operating device 801 is configured to be able to input an instruction for an operation target (which of the constituent elements is used as the operation target) and a moving direction of the operation target, similarly to a game pad and the like, for example.

For example, the inspector on the same floor as the tightening device 100 instructs to perform part or all of the pieces of inspection work using the operating device 801 while visually checking the tightening device 100. The operating device 801 is connected to the controller 120 in a wired or wireless manner, and configured to transmit/receive information indicating the instruction and the like.

The controller 120 controls operation of each constituent element of the tightening device 100 in accordance with the instruction input from the operating device 801. The inspector may operate the operating device 801 while viewing a display device displaying a screen for selecting the instruction, a screen for displaying a state of the tightening device 100 (error information and the like), and the like. The operating device 801 may include the display device displaying these pieces of information. The operating device 801 may be connected to the display device displaying these pieces of information.

The inspector may cause the tightening device 100 to operate by remote control of the operating device 801 at a place distant from the floor. For example, the inspector operates the operating device 801 while viewing at least one of the image taken by the camera 202 and an image taken by a camera that is installed in advance to image the inside of the floor. These images are acquired via a network (any of a wired network and a wireless network), for example.

In this way, the tightening device according to the embodiment can reduce a load of the tightening operation for the bolt.

A computer program executed by the tightening device (controller) according to the embodiment is embedded and provided in a read only memory (ROM) and the like included in the controller, for example.

The computer program executed by the tightening device according to the embodiment may be recorded in a computer-readable recording medium such as a compact disc read only memory (CD-ROM), a flexible disk (FD), a compact disc recordable (CD-R), and a digital versatile disc (DVD), as an installable or executable file, and provided as a computer program product.

Furthermore, the computer program executed by the tightening device according to the embodiment may be stored in a computer connected to a network such as the Internet and provided by being downloaded via the network. Alternatively, the computer program executed by the tightening device according to the embodiment may be provided or distributed via a network such as the Internet.

The computer program executed by the tightening device according to the embodiment may cause a computer to function as each part of the tightening device described above. In this computer, a central processing unit (CPU) can read out a computer program from a computer-readable storage medium onto a main storage device, and execute the computer program.

The following describes configuration examples of the embodiment.

(Configuration example 1) A tightening device includes:
a mobile part configured to be able to move by driving control;
a bolt tensioner configured to perform a tightening operation for a bolt;
an operation part configured to operate the bolt tensioner by driving control;
a positioning part that is mounted on the mobile part and is mounted with the bolt tensioner and the operation part, the positioning part being configured to position a three-dimensional position of the bolt tensioner; and
a controller configured to:
   cause the mobile part to move so that a distance to the bolt falls within a certain value;
   cause the positioning part to operate so that the three-dimensional position becomes a position where the bolt is tightened after the mobile part is moved; and
   drive the operation part so that the bolt tensioner performs the tightening operation after the three-dimensional position is determined to be the position where the bolt is tightened.

(Configuration example 2) In the tightening device according to Configuration example 1, the mobile part includes: a mobile-part driving part configured to perform forward movement, backward movement, turning, and movement along a circular arc track of the mobile part; and an outrigger configured to be able to extend in a moving direction of a center of gravity corresponding to positioning of the bolt tensioner.

(Configuration example 3) In the tightening device according to Configuration example 2, the device further includes: a first detection part configured to detect first detection information indicating at least one of a self-position and an obstacle; and a second detection part configured to detect a position of the bolt, and the controller is configured to cause the mobile part to move so that a distance from the bolt falls within a certain value by controlling the mobile-part driving part using the first detection information and the position of the bolt.

(Configuration example 4) In the tightening device according to any one of Configuration examples 1 to 3, the positioning part includes: a first driving part having three or more degrees of freedom, the first driving part being configured to cause the bolt tensioner to move in a first direction; and a second driving part configured to cause the bolt tensioner to move in a second direction orthogonal to the first direction.

(Configuration example 5) In the tightening device according to Configuration example 4, the controller is configured to: cause the mobile part to move to a position where a distance from the bolt falls within a certain value in a state where the bolt tensioner is positioned to be higher than the bolt; drive the first driving part so that the bolt tensioner moves to an upper position of the bolt; and drive the second driving part so that the bolt tensioner moves until contacting with the bolt after the bolt tensioner is located at the upper position of the bolt.

(Configuration example 6) In the tightening device according to any one of Configuration examples 1 to 5, the bolt tensioner includes: a female screw part configured to be attached to the bolt; a female screw rotation part configured to rotate the female screw part; and a nut rotation part configured to rotate a nut for tightening the bolt, and the operation part includes: a female screw rotational driving part configured to perform driving control for a wrench configured to rotate the female screw rotation part; and a nut rotational driving part configured to perform driving control for a wrench configured to rotate the nut rotation part.

(Configuration example 7) In the tightening device according to Configuration example 6, the operation part further comprises an imaging unit for taking an image of the bolt, and the controller is configured to: cause the positioning part to move to a position where the image of the bolt is taken by the imaging unit after the mobile part is moved; and cause the positioning part to operate so that the three-dimensional position becomes the position where the bolt is tightened by driving control using the taken image after the positioning part is moved.

(Configuration example 8) In the tightening device according to Configuration example 6, the controller is configured to: cause the positioning part to operate so that the bolt tensioner is lowered in accordance with a movement amount corresponding to a screw pitch of the bolt of the female screw part to be attached to the bolt by rotation, and detect that the three-dimensional position becomes the position where the bolt is tightened, based on whether torque of the female screw rotational driving part has reached a target value, or variation of a current for driving the female screw rotational driving part.

(Configuration example 9) In the tightening device according to Configuration example 6, the controller is configured to detect whether to end the tightening operation by the bolt tensioner based on whether torque of the nut rotational driving part has reached a target value, or variation of a current for driving the nut rotational driving part.

(Configuration example 10) In the tightening device according to Configuration example 6, the operation part further comprises a third detection part configured to detect second detection information indicating a rotation amount by at least one of the female screw rotational driving part and the nut rotational driving part, and the controller is configured to cause a storage device to store the second detection information.

(Configuration example 11) In the tightening device according to any one of Configuration examples 1 to 10, the device further includes: a hydraulic pressure supply part configured to supply hydraulic pressure to the bolt tensioner, and the hydraulic pressure supply part includes: a pressurizing bar configured to increase the hydraulic pressure by performing swing operation; a switching part configured to switch whether to apply the hydraulic pressure; a swing driving part configured to perform swing operation of the pressurizing bar; and a switching driving part configured to perform switching operation of the switching part, and the controller is configured to control the swing driving part based on a value of the detected hydraulic pressure.

(Configuration example 12) In the tightening device according to Configuration example 11, the device further includes: an attachment part for attaching the hydraulic pressure supply part, and the attachment part includes a rotation shaft for changing orientation of the attached hydraulic pressure supply part.

(Configuration example 13) In the tightening device according to any one of Configuration examples 1 to 12, the controller is configured to perform some or all of a movement operation for causing the mobile part to move, a positioning operation for causing the positioning part to operate, and the tightening operation in accordance with an instruction input from an operating device.

(Configuration example 14) A control method is performed by a tightening device,
the tightening device including:
   a mobile part configured to be able to move by driving control;
   a bolt tensioner configured to perform a tightening operation for a bolt;
   an operation part configured to operate the bolt tensioner by driving control; and
   a positioning part that is mounted on the mobile part and is mounted with the bolt tensioner and the operation part, the positioning part being configured to position a three-dimensional position of the bolt tensioner, and
the control method including:
   causing the mobile part to move so that a distance to the bolt falls within a certain value;
   causing the positioning part to operate so that the three-dimensional position becomes a position where the bolt is tightened after the mobile part is moved; and
   driving the operation part so that the bolt tensioner performs the tightening operation after the three-dimensional position is determined to be the position where the bolt is tightened.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A tightening device comprising:
a mobile part configured to be able to move by driving control;
a bolt tensioner configured to perform a tightening operation for a bolt;
an operation part configured to operate the bolt tensioner by driving control;
a positioning part that is mounted on the mobile part and is mounted with the bolt tensioner and the operation part, the positioning part being configured to position a three-dimensional position of the bolt tensioner; and
a controller configured to:
cause the mobile part to move so that a distance to the bolt falls within a certain value;
cause the positioning part to operate so that the three-dimensional position becomes a position where the bolt is tightened after the mobile part is moved; and
drive the operation part so that the bolt tensioner performs the tightening operation after the three-dimensional position is determined to be the position where the bolt is tightened.

2. The tightening device according to claim 1, wherein
the mobile part comprises:
a mobile-part driving part configured to perform forward movement, backward movement, turning, and movement along a circular arc track of the mobile part; and
an outrigger configured to be able to extend in a moving direction of a center of gravity corresponding to positioning of the bolt tensioner.

3. The tightening device according to claim 2, further comprising:
a first detection part configured to detect first detection information indicating at least one of a self-position and an obstacle; and
a second detection part configured to detect a position of the bolt, wherein
the controller is configured to cause the mobile part to move so that a distance from the bolt falls within a certain value by controlling the mobile-part driving part using the first detection information and the position of the bolt.

4. The tightening device according to claim 1, wherein
the positioning part comprises:
a first driving part having three or more degrees of freedom, the first driving part being configured to cause the bolt tensioner to move in a first direction; and
a second driving part configured to cause the bolt tensioner to move in a second direction orthogonal to the first direction.

5. The tightening device according to claim 4, wherein
the controller is configured to:
cause the mobile part to move to a position where a distance from the bolt falls within a certain value in a state where the bolt tensioner is positioned to be higher than the bolt;
drive the first driving part so that the bolt tensioner moves to an upper position of the bolt; and
drive the second driving part so that the bolt tensioner moves until contacting with the bolt after the bolt tensioner is located at the upper position of the bolt.

6. The tightening device according to claim 1, wherein
the bolt tensioner comprises:
a female screw part configured to be attached to the bolt;
a female screw rotation part configured to rotate the female screw part; and
a nut rotation part configured to rotate a nut for tightening the bolt, and
the operation part comprises:
a female screw rotational driving part configured to perform driving control for a wrench configured to rotate the female screw rotation part; and
a nut rotational driving part configured to perform driving control for a wrench configured to rotate the nut rotation part.

7. The tightening device according to claim 6, wherein
the operation part further comprises an imaging unit for taking an image of the bolt, and
the controller is configured to:
cause the positioning part to move to a position where the image of the bolt is taken by the imaging unit after the mobile part is moved; and
cause the positioning part to operate so that the three-dimensional position becomes the position where the bolt is tightened by driving control using the taken image after the positioning part is moved.

8. The tightening device according to claim 6, wherein
the controller is configured to:
cause the positioning part to operate so that the bolt tensioner is lowered in accordance with a movement amount corresponding to a screw pitch of the bolt of the female screw part to be attached to the bolt by rotation, and
detect that the three-dimensional position becomes the position where the bolt is tightened, based on whether torque of the female screw rotational driving part has reached a target value, or variation of a current for driving the female screw rotational driving part.

9. The tightening device according to claim 6, wherein the controller is configured to detect whether to end the tightening operation by the bolt tensioner based on whether torque of the nut rotational driving part has reached a target value, or variation of a current for driving the nut rotational driving part.

10. The tightening device according to claim 6, wherein
the operation part further comprises a third detection part configured to detect second detection information indicating a rotation amount by at least one of the female screw rotational driving part and the nut rotational driving part, and
the controller is configured to cause a storage device to store the second detection information.

11. The tightening device according to claim 1, further comprising:
a hydraulic pressure supply part configured to supply hydraulic pressure to the bolt tensioner, wherein
the hydraulic pressure supply part comprises:
a pressurizing bar configured to increase the hydraulic pressure by performing swing operation;
a switching part configured to switch whether to apply the hydraulic pressure;
a swing driving part configured to perform swing operation of the pressurizing bar; and
a switching driving part configured to perform switching operation of the switching part, and
the controller is configured to control the swing driving part based on a value of the detected hydraulic pressure.

12. The tightening device according to claim 11, further comprising:
an attachment part for attaching the hydraulic pressure supply part, wherein
the attachment part includes a rotation shaft for changing orientation of the attached hydraulic pressure supply part.

13. The tightening device according to claim 1, wherein the controller is configured to perform some or all of a movement operation for causing the mobile part to move, a positioning operation for causing the positioning part to operate, and the tightening operation in accordance with an instruction input from an operating device.

14. A control method performed by a tightening device,
the tightening device comprising:
a mobile part configured to be able to move by driving control;
a bolt tensioner configured to perform a tightening operation for a bolt;
an operation part configured to operate the bolt tensioner by driving control; and
a positioning part that is mounted on the mobile part and is mounted with the bolt tensioner and the operation part, the positioning part being configured to position a three-dimensional position of the bolt tensioner, and
the control method comprising:
causing the mobile part to move so that a distance to the bolt falls within a certain value;
causing the positioning part to operate so that the three-dimensional position becomes a position where the bolt is tightened after the mobile part is moved; and
driving the operation part so that the bolt tensioner performs the tightening operation after the three-dimensional position is determined to be the position where the bolt is tightened.
